(19) United States
(12) Patent Application Publication
(10) Pub. No.: US 2025/0007253 A1
(43) Pub. Date: Jan. 2, 2025

(54) ISOLATION SWITCHES WITH SHIELDED CONTACT STRUCTURES FOR MOTOR CONTROL CENTER APPLICATIONS

(71) Applicant: Eaton Intelligent Power Limited, Dublin 4 (IE)

(72) Inventors: Ravindra Rikame, Nashik (IN); Thomas Farr, Candler, NC (US); Nitish G. Patwardhan, Pune (IN); Prince Ramanan, Pune (IN); Namrata Thorat, Satara (IN); Richard Bhalla, Fletcher, NC (US)

(21) Appl. No.: 18/756,556

(22) Filed: Jun. 27, 2024

Related U.S. Application Data
(60) Provisional application No. 63/511,245, filed on Jun. 30, 2023.

(51) Int. Cl. H02B 11/04; H01H 9/10; H01H 9/24; H01H 9/30; H02B 11/133

(52) U.S. Cl. CPC H02B 11/04; H01H 9/10; H01H 9/24; H01H 9/30; H02B 11/133

(57) ABSTRACT

A cell for a motor control center (MCC) includes an isolation switch configured to receive power from a power source and a contactor configured to receive power from the isolation switch and to selectively provide power to a load. The isolation switch may include a first and second contacts that are configured to engage and disengage from one another and at least one insulating barrier surrounding the first and second contacts and configured to maintain insulation around the first and second contacts when engaging and disengaging the first and second contacts. The at least one insulating barrier may include a first insulating barrier surrounding the first contact and a second insulating barrier surrounding the second contact and configured to be inserted into the first insulating barrier such that the first insulating barrier at least partially overlaps the second insulating barrier when the first and second contacts are engaged.

### BACKGROUND

The inventive concept relates to motor control centers (MCCs) and, more particularly, to isolation switch structures for cells of MCCs.

A power distribution cell for an MCC may include a contactor that receives power from an external source and distributes power to other cells in the MCC. The power distribution cell may include a contactor that is configured to interrupt power flow to the other cells. Fuses may be provided in line with the contactor to protect against load side faults. The power distribution cell may further include an isolation switch that can be used to safely disconnect the power distribution cell and loads connected thereto from the external power source to help insure safe access for maintenance operations on the MCC.

### SUMMARY

Some embodiments provide a cell for a motor control center (MCC). The cell includes an isolation switch configured to receive power from a power source and a contactor configured to receive power from the isolation switch and to selectively provide power to a load. The isolation switch includes a first contact and a second contact that are configured to engage and disengage from one another and at least one insulating barrier surrounding the first and second contacts and configured to maintain insulation around the first and second contacts when engaging and disengaging the first and second contacts.

In some embodiments, the at least one insulating barrier may include a first insulating barrier surrounding the first contact and a second insulating barrier surrounding the second contact. The second insulating barrier may be configured to be inserted into the first insulating barrier such that the first insulating barrier at least partially overlaps the second insulating barrier when the first and second contacts are engaged. The first insulating barrier may continue to at least partially overlap the second insulating barrier as the first and second contacts are disengaged. The first contact and the first insulating barrier may be fixed and the second contact and the second insulating barrier may be configured to move to engage and disengage the first and second contacts.

In further embodiments, the first contact may include a pair of spaced apart first contacts and the second contact may include a single second contact configured to be inserted between the pair of spaced apart first contacts. The second contact may include a spring contact member surrounding a central core contact member and configured to be compressed between the core contact member and the spaced apart first contacts when the second contact is inserted between the spaced apart first contacts.

In some embodiments, the at least one insulating barrier may include a barrel contact housing. The first contact may be positioned in the barrel contact housing and the second contact may be configured to be inserted into the barrel contact housing to engage the first contact. The first contact may include a tulip contact and the second contact may include a tube contact. The barrel contact housing may be sufficiently long to surround the pipe contact after disengagement of the pipe contact from the tulip contact.

Further embodiments provide an MCC cell including an isolation switch configured to receive power from a power source and a contactor configured to receive power from the isolation switch and to selectively provide power to a load. The isolation switch includes a first contact, a first insulation barrier surrounding the first contact, a second contact configured to engage and disengage the first contact, and a second insulating barrier surrounding the second contact and configured to receive and surround the first insulating barrier and the first contact when the first and second contacts are engaged. The first insulating barrier may continue to at least partially overlap the second insulating barrier as the first and second contacts are disengaged. The first contact and the first insulating barrier may be fixed and the second contact and the second insulating barrier may be configured to move to engage and disengage the first and second contacts.

In some embodiments, the first contact may include a pair of spaced apart first contacts and the second contact may include a single second contact configured to be inserted between the pair of spaced apart first contacts. The second contact may include a spring contact member surrounding a central core contact member and configured to be compressed between the core contact member and the spaced apart first contacts when the second contact is inserted between the spaced apart first contacts.

The cell may include an actuator assembly comprising a carriage that supports the second contact and the second insulating barrier and moves linearly to engage and disengage the first contact and the second contact. The cell may include a crank arm configured to move the carriage and a crank shaft that rotates to drive the crank arm. The cell may include an actuator motor configured to rotate the crank shaft. The cell may also include a switch lever configured to actuate the crank shaft using a Geneva mechanism that engages a slotted member attached to the crank shaft, wherein the Geneva mechanism disengages from the slotted member when fully in either an on position or an off position.

### BRIEF DESCRIPTION OF THE DRAWINGS

FIG. 1 illustrates a motor control center (MCC).

FIG. 2 is a perspective view of an MCC cell according to some embodiments.

FIG. 3 is a side view of the MCC cell of FIG. 2.

FIGS. 4 and 5 illustrate a portion of an isolation switch of the MCC cell of FIGS. 2 and 3 according to some embodiments.

FIG. 6 illustrates contact engagement for the isolation switch of FIGS. 4 and 5.

FIG. 7 illustrates a conductive contact spring used in the contact arrangement of FIGS. 4 and 5.

FIG. 8 is a detailed view of an isolation switch of the MCC cell of FIG. 7 in an open position.

FIG. 9 is a perspective view of the isolation switch of FIG. 8 in the open position.

FIG. 10 is a detailed view of the isolation switch of FIG. 8 in a closed position.

FIG. 11 is a perspective view of the isolation switch of FIG. 8 in the closed position.

FIG. 12 illustrates a modified Geneva mechanism for actuation of an isolation switch according to further embodiments.

FIGS. 13 and 14 illustrate an isolation switch using a lead screw actuator according to further embodiments.

FIGS. 15 and 16 illustrate an isolation switch with a barrel-shaped contact insulator arrangement according to further embodiments.

### DETAILED DESCRIPTION

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items. Similarly, as used herein, the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Reference will now be made in detail in various and alternative example embodiments and to the accompanying figures. Each example embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their equivalents.

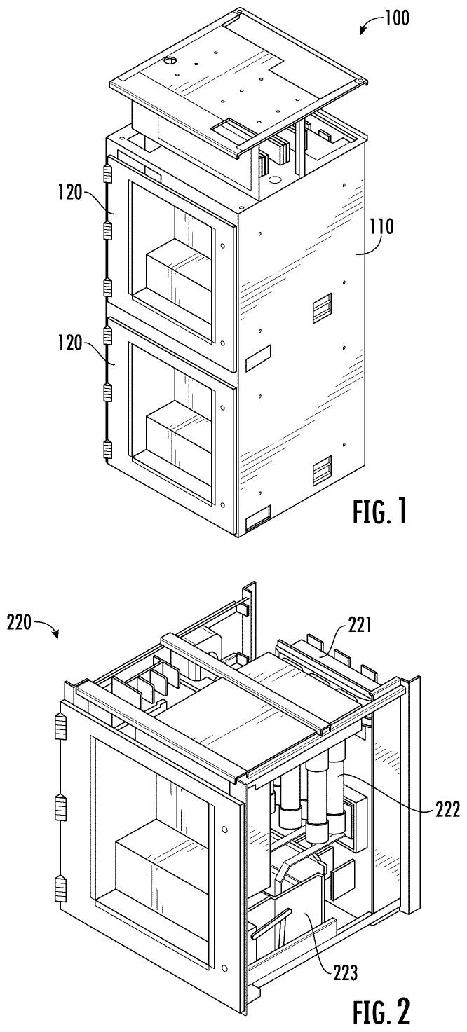

FIG. 1 illustrates an MCC 100 in which embodiments of the inventive concept may be employed. The MCC 100 includes a sheet metal enclosure 110 in which a plurality of MCC cells 120 are housed. The MCC cells 120 may include any of a number of different devices, such as switches, circuit breakers, motor starters, motor drives, power fuses, transformers, and the like.

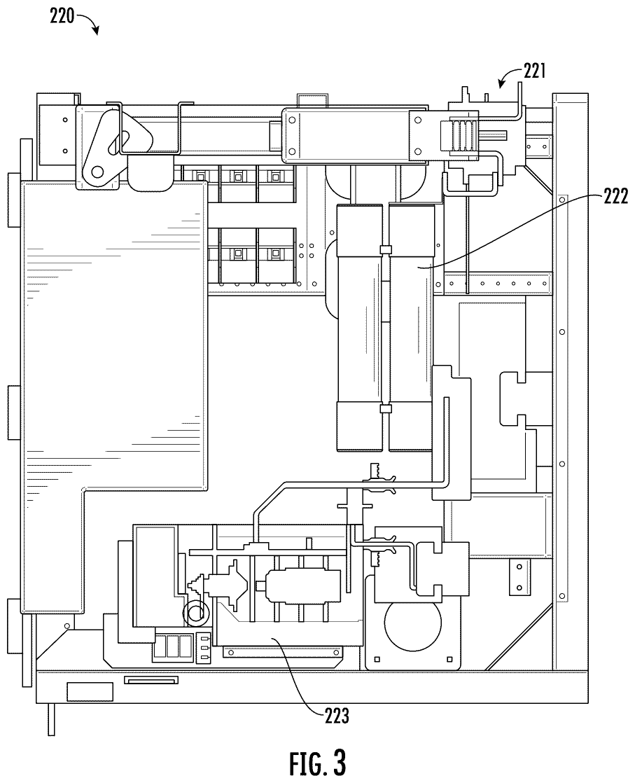

FIGS. 2 and 3 illustrate a cell 220 that may be housed in an MCC and used to distribute power from a main bus of the MCC to other devices in the MCC. The cell 220 includes an input isolation switch 221, fuses 222 and a contactor 223. Line power may be received by the isolation switch 221. Power passes from the isolation switch 221 to the contactor 223 via the fuses 222. The contactor 223 may distribute power to other components of the MCC and/or to a load connected to the MCC.

As part of maintenance operations, the isolation switch 221 may be used to disconnect line power from the MCC after the contactor 223 has opened to remove the load, thus assuring that line power is not provided to the rest of the MCC. When operated, such an isolation switch may cause arcing, which can pose a danger to personnel operating the switch. The isolation switch 221 according to some embodiments of the inventive concept can reduce the risk associated by such events by employing a contact structure that maintains an insulating shield (barrier) around the switch contacts as they are inserted or removed.

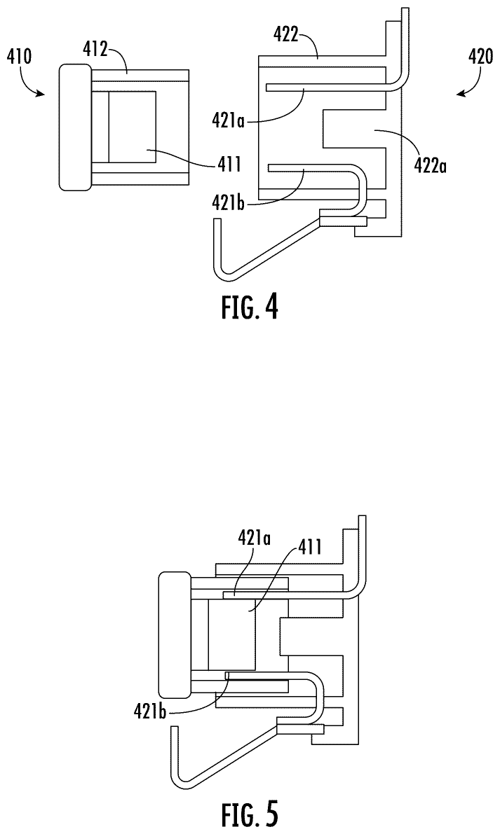

FIGS. 4 and 5 schematically illustrate components of the isolation switch 221. The switch includes a moving portion 410 including a contact 411 positioned in a cavity within a first insulating housing 412. A fixed portion 420 of the switch includes fixed contacts 421a, 421b that are positioned within a cavity of a second insulating housing 422, which includes an insulating portion 422a that extends between the fixed contacts 421a, 421b. The upper fixed contact 421a is electrically connected to a power source, such as a line side bus bar of the MCC. The lower fixed contact 421b may be electrically connected to a fuse, such as one of the fuses 222 shown in FIG. 2). The second insulating housing 422 is configured to receive the first insulating housing 412 and the contact 411 therein, such that, when the moving and fixed portions 410, 420 are mated, the outer walls of the second insulating housing 422 overlap the outer walls of the first insulating housing 412. When the moving portion 410 is inserted into the fixed portion 420, the moving contact 411 is inserted between and contacts the fixed contacts 421a, 421b, creating an electrical connection between the fixed contacts 421a, 421b.

The illustrated contact arrangement may be advantageous for several reasons. Conventional isolation units may use a single moving and fixed contact pair wherein the moving contact is connected to the line or load side by a flexible connector that allows for movement of the contact. The use of fixed contacts with an intervening moving contact according to embodiments of the invention can eliminate the need for such a flexible connection.

In addition, the overlapping first and second insulating housings 412, 422 can maintain an insulation barrier that surrounds the contacts 411, 421a, 421b as they are connected and disconnected. In the embodiment illustrated, for example, the first insulating housing 412 may be partially withdrawn from the second housing 422 to separate the moving contact 411 from the fixed contacts 421a, 421b while maintaining an insulating shield around the contact area while the moving contact 411 is still in proximity to the fixed contacts 421a, 421b. This can reduce or prevent arcing between phases and thus improve safety for a user operating the isolation switch.

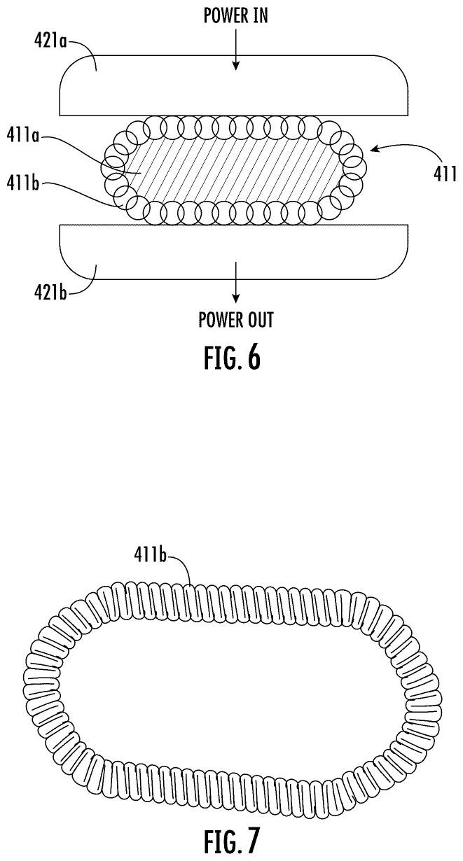

FIGS. 6 and 7 illustrate an example of a contact configuration for the moving contact 411 and the fixed contacts 421a, 421b. The moving contact 411 may include conductive (e.g., copper) core 411. The core 411a is surrounded by a resilient, spring-like conductive coil 411b, which may be seated, for example, in a circumferential groove running around the core 411a. When the moving contact 411 is inserted between the fixed contacts 421a, 421b, the coil 411b provides a pressure contact between the opposing surfaces of the fixed contacts 421a, 421b and the core 411a. This can provide a secure connection between the fixed contacts 421a, 421b via a current path passing through the coil 411b and the conductive core 411a.

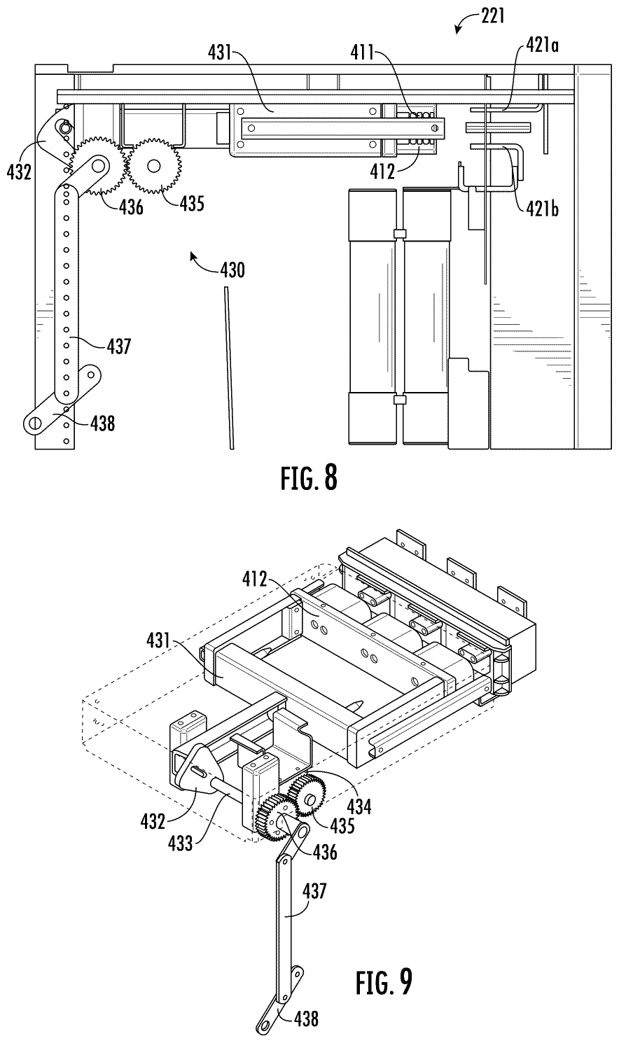

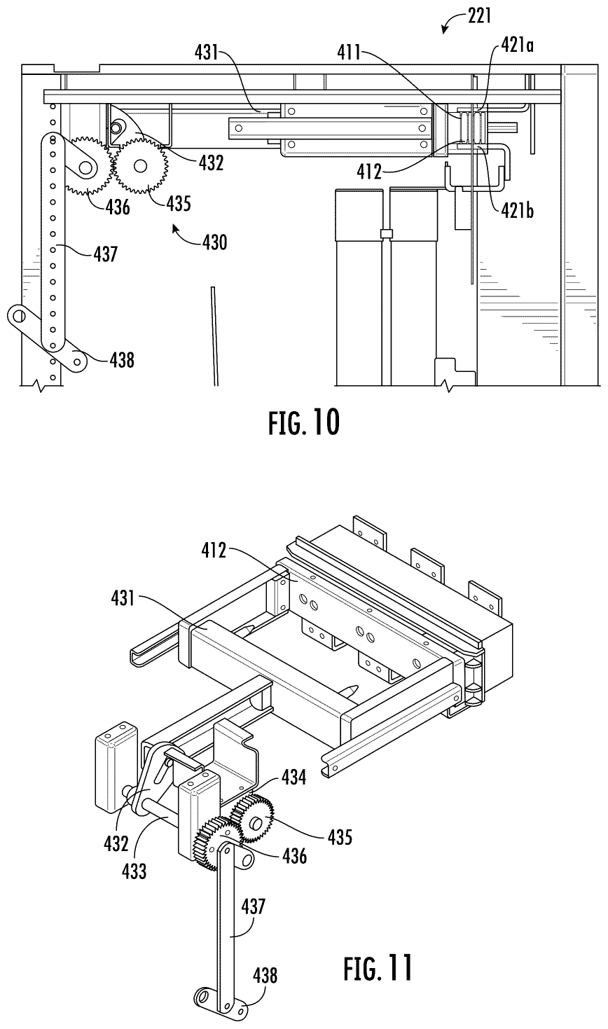

FIGS. 8 and 9 illustrate the isolation switch 221 in open state, while FIGS. 10 and 11 illustrate the isolation switch 221 in a closed state. Transition between the open and closed states is effectuated using an actuator assembly 430 that includes a carriage 431 that supports the moving contact housing 412 and moves linearly to engage and disengage the contacts of the isolation switch 221. The carriage 431 is moved by a crank arm 432 driven by rotation of a crank shaft 433. The crank shaft 433 may be driven by an actuator motor 434 via a first gear 435 and a second gear 436, the latter of which is coaxially connected to the crankshaft 433. For manual operation, the crankshaft 433 may also be driven by a switch lever (e.g., an on/off switch lever) 438 via a linkage 437.

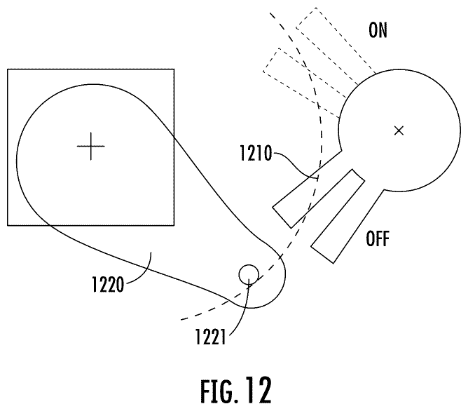

In some embodiments, such a switch lever could be linked to the crank shaft 433 using a modified Geneva mechanism as shown in FIG. 12. In particular, the crank shaft 433 may have a slotted member 1210 attached thereto. A lever arm 1220 (e.g., a lever arm linked to an on/off switch lever such as the switch lever 430 in FIGS. 8-11, may have a pin 1221 attached thereto that is configured to engage the slotted member 1210 to effect rotation of the crank shaft, but disengages from the slotted member 1212 when fully in either the “on” position or the “on” position.

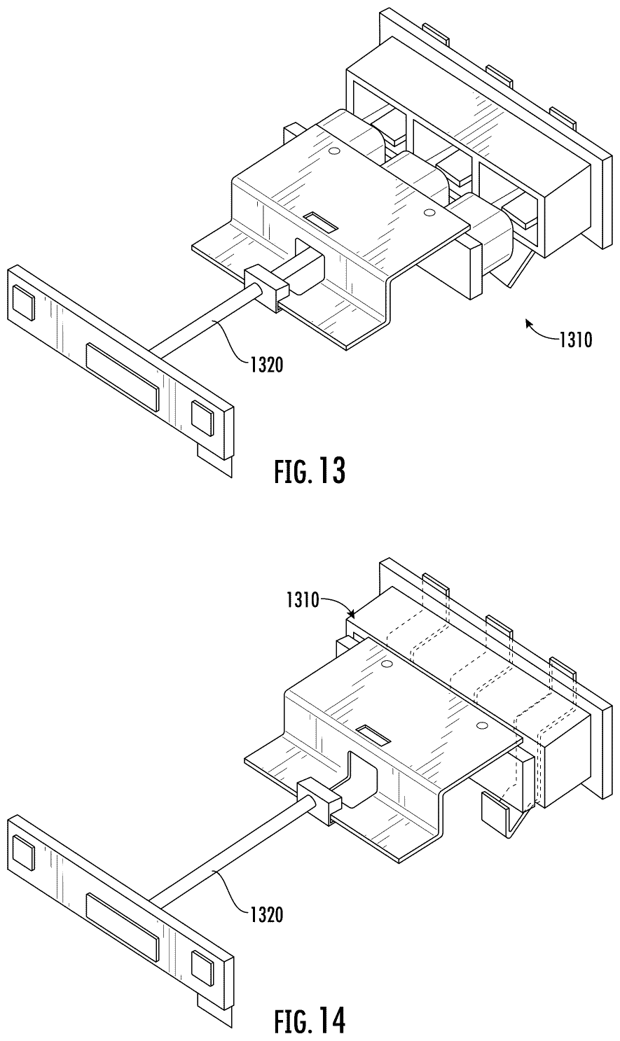

FIGS. 13 and 14 illustrate an alternative actuator arrangement according to further embodiments. In these embodiments, a moving contact assembly 1310 along the lines discussed above is actuated by a lead screw 1320, which may be driven, for example, by an actuator motor and/or a manual actuator.

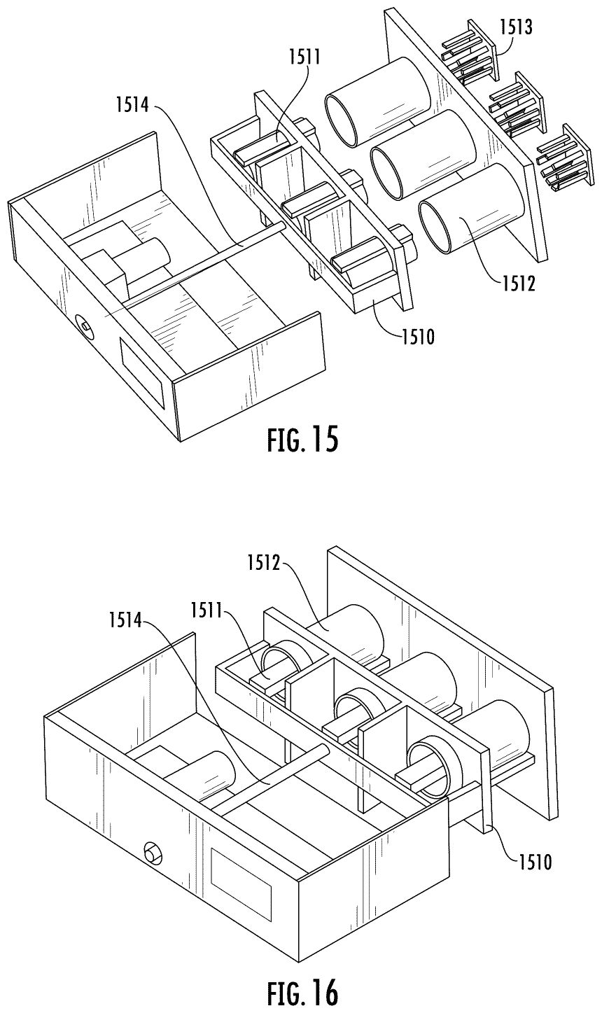

FIGS. 15 and 16 illustrate an alternative contact arrangement for an isolation switch. In these embodiments, a moving contact assembly 1510 includes contacts 1511 that are configured to be inserted in barrel-shaped insulating housings 1512 that house fixed tulip contacts 1513. Similar to the contact arrangements discussed above, the insulated housings 1512 may provide an insulated shield that reduces or prevents arcing between phases when mating and disengaging the contacts 1511, 1513. In these embodiments, the moving contacts 1511 may be electrically connected to a load (e.g., via a fuse along the lines discussed above) using a flexible conductor, while the fixed tulip contacts 1513 may be connected to power source, such as an MCC bus bar. The moving contact assembly 1510 may be actuated by a lead screw 1514 as shown. In some embodiments, an actuator mechanism along the lines shown in FIGS. 8-11 may be used.

In the specification, there have been disclosed embodiments of the inventive concept and, although specific terms are used, they are used in a generic and descriptive sense only and not for purposes of limitation.

What is claimed is:

1. A cell for a motor control center (MCC), the cell comprising:
an isolation switch configured to receive power from a power source; and
a contactor configured to receive power from the isolation switch and to selectively provide power to a load,
wherein the isolation switch comprises a first contact and a second contact that are configured to engage and disengage from one another and at least one insulating barrier surrounding the first and second contacts and configured to maintain insulation around the first and second contacts when engaging and disengaging the first and second contacts.

2. The cell of claim 1, wherein the at least one insulating barrier comprises:
a first insulating barrier surrounding the first contact; and
a second insulating barrier surrounding the second contact.

3. The cell of claim 2, wherein the second insulating barrier is configured to be inserted into the first insulating barrier such that the first insulating barrier at least partially at least partially overlaps the second insulating barrier when the first and second contacts are engaged.

4. The cell of claim 3, wherein the first insulating barrier continues to at least partially overlap the second insulating barrier as the first and second contacts are disengaged.

5. The cell of claim 2, wherein the first contact and the first insulating barrier are fixed and wherein the second contact and the second insulating barrier are configured to move to engage and disengage the first and second contacts.

6. The cell of claim 2, wherein the first contact comprises a pair of spaced apart first contacts and wherein the second contact comprises a single second contact configured to be inserted between the pair of spaced apart first contacts.

7. The cell of claim 6, wherein the second contact comprises a spring contact member surrounding a central core contact member and configured to be compressed between the core contact member and the spaced apart first contacts when the second contact is inserted between the spaced apart first contacts.

8. The cell of claim 1:
wherein the at least one insulating barrier comprises a barrel contact housing;
wherein the first contact is positioned in the barrel contact housing; and
wherein the second contact is configured to be inserted into the barrel contact housing to engage the first contact.

9. The cell of claim 8, wherein the first contact comprises a tulip contact and wherein the second contact comprises a tube contact.

10. The cell of claim 9, wherein the barrel contact housing is sufficiently long to surround the pipe contact after disengagement of the pipe contact from the tulip contact.

11. The cell of claim 1, further comprising a fuse connecting the isolation switch to the contactor.

12. A cell for a MCC, the cell comprising:
an isolation switch configured to receive power from a power source; and
a contactor configured to receive power from the isolation switch and to selectively provide power to a load,
wherein the isolation switch comprises:
a first contact;
a first insulation barrier surrounding the first contact;
a second contact configured to engage and disengage the first contact;
a second insulating barrier surrounding the second contact and configured to receive and surround the first insulating barrier and the first contact when the first and second contacts are engaged.

13. The cell of claim 12, wherein the first insulating barrier continues to at least partially overlap the second insulating barrier as the first and second contacts are disengaged.

14. The cell of claim 12, wherein the first contact and the first insulating barrier are fixed and wherein the second contact and the second insulating barrier are configured to move to engage and disengage the first and second contacts.

15. The cell of claim 12, wherein the first contact comprises a pair of spaced apart first contacts and wherein the second contact comprises a single second contact configured to be inserted between the pair of spaced apart first contacts.

16. The cell of claim 15, wherein the second contact comprises a spring contact member surrounding a central core contact member and configured to be compressed between the core contact member and the spaced apart first contacts when the second contact is inserted between the spaced apart first contacts.

17. The cell of claim 12, further comprising an actuator assembly comprising a carriage that supports the second contact and the second insulating barrier and moves linearly to engage and disengage the first contact and the second contact.

18. The cell of claim 17, further comprising a crank arm configured to move the carriage and a crank shaft that rotates to drive the crank arm.

19. The cell of claim 18, further comprising an actuator motor configured to rotate the crank shaft.

20. The cell of claim 19, further comprising a switch lever configured to actuate the crank shaft using a Geneva mechanism that engages a slotted member attached to the crank shaft, wherein the Geneva mechanism disengages from the slotted member when fully in either an on position or an off position.
